(19) United States
(12) Patent Application Publication
(10) Pub. No.: US 2024/0101879 A1
(43) Pub. Date: Mar. 28, 2024

(54) Storage-Stable 1K Spray Adhesives Based on Polyurethane Dispersions

(71) Applicant: Covestro Deutschland AG, Leverkusen (DE)

(72) Inventors: Christoph Thiebes, Köln (DE); Sebastian Doerr, Düsseldorf (DE); Jan Weikard, Leverkusen (DE); Peter Kueker, Leverkusen (DE); Harald Kraus, Leverkusen (DE); Wolfgang Arndt, Dormagen (DE); Robert Liberati, Hürth- Efferen (DE)

(21) Appl. No.: 18/272,902

(22) PCT Filed: Jan. 14, 2022
(86) PCT No.: PCT/EP2022/050709

§ 371 Date: Jul. 18, 2023

(30) Foreign Application Priority Data
Jan. 19, 2021 (EP) 21152261.0
Jun. 1, 2021 (EP) 21177062.3

(51) Int. Cl. C09J 175/04; C09J 11/04; C09J 11/08

(52) U.S. Cl. CPC C09J 175/04; C09J 11/04; C09J 11/08; C09J 2301/312; C09J 2301/408

(57) ABSTRACT

An aqueous adhesive formulation; containing a mixture of: at least one partially crystallised or crystalline polyurethane having a fusion temperature of 35 to 80° C. and an enthalpy of fusion of ≥35 J/g as component A; at least one plasticiser as component B; at least one salt as component C; and optionally at least one further polymer as component D. The mixture contains: 30 to 94.9 wt. % component A; 5 to 45 wt. % component B; 0.001 to 3 wt. % component C; and optionally 0 to 30 wt. % component D, each based on the total of the amounts of the components A, B, C and optionally D present in the mixture.

### CROSS-REFERENCE TO RELATED APPLICATIONS

This application is the United States national phase of International Application No. PCT/EP2022/050709 filed Jan. 14, 2022, and claims priority to European Patent Application Nos. 21152261.0 filed Jan. 19, 2021 and 21177062.3 filed Jun. 1, 2021, the disclosures of which are hereby incorporated by reference in their entireties.

### BACKGROUND OF THE INVENTION

### Field of the Invention

The present invention relates to an aqueous adhesive formulation comprising a mixture of at least one semicrystalline or crystalline polyurethane having a melting temperature of 35 to 80° C. and an enthalpy of fusion of ≥35 J/g as component A, at least one plasticizer as component B, at least one salt as component C, and optionally at least one further polymer as component D, to a method for producing the aqueous adhesive formulation by mixing the individual components, to a method for producing an adhesive bond between substrates, characterized in that an adhesive formulation according to the invention is applied to at least one substrate, after which bonding takes place, to a method for producing a composite material by bonding the individual joining parts of the composite material using the aqueous adhesive formulation, and to the use of the aqueous adhesive formulation for the bonding of wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case with one another and/or on porous substrates, preferably having a density of less than 1 kg/liter, especially for the bonding of foams in the adhesive bonding of mattresses, furniture and/or upholstery.

### Description of Related Art

The following two methods are commonly used, especially when bonding foams in the manufacture of mattresses and furniture:

In the 2K (2-component) method, the adhesive formulation and aqueous coagulant are atomized separately at the same time using a spray gun that has two nozzles. The two mixtures meet in the spray jet and coagulate there and/or on the substrate surface. However, this method is prone to problems and is difficult to operate, since both components have to be atomized consistently in a defined mixing profile.

In the 1K (1-component) method, an aqueous adhesive formulation is sprayed through a spray gun having one nozzle, with the result that an adhesive layer is applied to the substrate to be bonded, which, on contacting two surfaces coated therewith under moderate pressure, immediately or at least shortly after application builds up sufficient adhesion and cohesive strength that at least the restoring forces that develop during bonding of foam substrates are absorbed and the contacted surfaces do not separate from one another. The formulation should here be storage stable and during a period of storage should not show any significant coagulation that would potentially result in clogging of the nozzle.

Important fields of application for this spray coagulation method are the manufacture of mattresses and seating furniture. There is a market demand for alternatives to the customary polychloroprene dispersion adhesives, in order for example to be able to meet the future requirements of eco-labels that limit the use of organochlorine compounds.

Sprayable adhesive formulations based on polyurethane dispersions are known per se to those skilled in the art and are used in various areas, including foam bonding in the mattress and furniture sectors using the 2K method.

The documents WO 2020/064829 A1 and WO 2020/064826 A1 describe the use of adhesive formulations based on polyurethane dispersions and plasticizers for the 2K spray coagulation method. Storage-stable aqueous adhesive formulations that can be used for the 1K spray coagulation method are not mentioned.

Adhesives based on aqueous polyurethane dispersions have become established worldwide in other demanding industrial uses, for example in shoe manufacture, in the bonding of parts for motor vehicle interiors, in sheet lamination or in the bonding of textile substrates.

When using such adhesives based on aqueous polyurethane dispersions for the bonding of substrates, this is commonly done by the heat-activation method. In this method, the dispersion is applied to the substrate and, after complete evaporation of the water, the adhesive layer is activated and converted into an adhesive state by heating, for example with an infrared radiator. The temperature at which the adhesive film becomes tacky is referred to as the activation temperature.

When using polyurethane dispersions, it is however also possible to employ the wet bonding method, i.e. forming the adhesive bond by joining together the applied adhesive layers directly after the adhesive has been applied, but at the latest before film formation is complete, while the adhesive layers still contain appreciable amounts of water. Mechanical fixing of the parts to be joined is generally necessary until the adhesive has set. This method is often used for the bonding of wood or textile substrates.

However, neither the heat-activation method nor the wet-bonding method are very suitable for the bonding of foam substrates. In particular, the slow evaporation of the water necessitates long wait times between application of the adhesive and the forming of an adhesive bond, or appropriate drying systems. Moreover, a not insignificant proportion of the adhesive may undergo diffusion into the pores of the foam substrates before or during drying and is then no longer available for the actual bonding.

### SUMMARY OF THE INVENTION

The object of the present invention is therefore to provide a corresponding adhesive formulation that does not have the described drawbacks. More particularly, a corresponding formulation should be provided that, even without the use of 2K methods, which require high outlay on equipment and are prone to errors, shows high initial strength immediately after application to the substrate, especially by spraying, can be stored for a long period without coagulating, and is essentially free of halogenated organic polymers. The formulation to be provided according to the invention should however nevertheless be suitable for use in a 2K method.

Surprisingly, it has according to the invention been found that aqueous formulations comprising at least one special polyurethane, at least one plasticizer, and at least one salt are storage stable, are suitable for the bonding of substrates by both the 1K method and the 2K method, and at the same time do not have the drawbacks of the prior art described above.

### DETAILED DESCRIPTION

The objects according to the invention are achieved by an aqueous adhesive formulation comprising a mixture of
(A) at least one semicrystalline or crystalline polyurethane having a melting temperature of 35 to 80° C. and an enthalpy of fusion of ≥35 J/g as component A,
(B) at least one plasticizer as component B,
(C) at least one salt as component C, and
(D) optionally at least one further polymer as component D,
the mixture being characterized in that it contains
   (A) 30% to 94.9% by weight of component A,
   (B) 5% to 45% by weight of component B,
   (C) 0.001% to 3% by weight of component C, and
   (D) optionally 0% to 30% by weight of component D,
in each case based on the sum total of the amounts of components A, B, C, and optionally D present in the mixture.

The individual components of the components present in the aqueous adhesive formulation according to the invention are described in detail below.

Component A:

The mixture according to the invention comprises as component A at least one semicrystalline or crystalline polyurethane having a melting temperature of 35 to 80° C. and an enthalpy of fusion of ≥35 J/g as component A.

The at least one polyurethane present as component A is generally one or more polyurethanes in the narrower sense, i.e. polymers obtained by polymerization of polyols and polyisocyanates, but they may also be ones in which monoamines and/or diamines are used as synthesis components, optionally as chain extenders. Thus, in the context of the present invention what is generally present as component A is at least one polyurethane, at least one polyurea and/or at least one polyurethaneurea.

The at least one polyurethane present according to the invention is referred to as semicrystalline or crystalline when it exhibits a melting peak in DSC measurement according to DIN 65467:1999-03 at a heating rate of 20 K/min. The melting peak is caused by the melting of regular substructures in the polyurethane. The melting temperature of the at least one polyurethane present in the formulation according to the invention is 35 to 80° C., preferably 40 to 70° C., more preferably 42 to 55° C.

The enthalpy of fusion of the at least one polyurethane used according to the invention is ≥35 J/g, preferably ≥45 J/g, more preferably ≥50 J/g.

In general, any polyurethane known to those skilled in the art may be used in the adhesive formulation of the invention. In a preferred embodiment of the present invention, the at least one polyurethane used as component A is formed from
A(i) at least one crystalline or semicrystalline difunctional polyester polyol having a number-average molecular weight of at least 400 g/mol and a melting temperature of at least 35° C. and a heat of fusion of at least 35 J/g,
A(ii) optionally at least one difunctional polyol component having a number-average molecular weight of 62 to 399 g/mol,
(Aiii) at least one isocyanate component,
(Aiv) at least one isocyanate-reactive component bearing at least one ionic or potentially ionic group, and
(Av) optionally further isocyanate-reactive components.

The at least one polyurethane contains for example 50% to 95% by weight of constituent A(i), 0% to 10% by weight of constituent A(ii), 4% to 25% by weight of constituent A(iii), 0.5% to 10% by weight of constituent A(iv), and 0% to 30% by weight of constituent A(v), where the sum total of the constituents adds up to 100% by weight.

In a preferred form of the invention, the at least one polyurethane contains 65% to 92% by weight of constituent A(i), 0% to 5% by weight of constituent A(ii), 6% to 15% by weight of constituent A(iii), 0.5% to 5% by weight of constituent A(iv), and 0% to 25% by weight of constituent A(v), where the sum total of the constituents adds up to 100% by weight.

In a particularly preferred form of the invention, the at least one polyurethane contains 75% to 92% by weight of constituent A(i), 0% to 5% by weight of constituent A(ii), 8% to 15% by weight of constituent A(iii), 0.5% to 4% by weight of constituent A(iv), and 0% to 15% by weight of constituent A(v), where the sum total of the constituents adds up to 100% by weight.

In a very particularly preferred form of the invention, the at least one polyurethane contains 80% to 90% by weight of constituent A(i), 0% to 3% by weight of constituent A(ii), 8% to 14% by weight of constituent A(iii), 0.5% to 3% by weight of constituent A(iv), and 0% to 10% by weight of constituent A(v), where the sum total of the constituents adds up to 100% by weight.

Suitable crystalline or semicrystalline difunctional polyester polyols A(i) are in particular linear or else slightly branched polyester polyols based on dicarboxylic acids and/or derivatives thereof such as anhydrides, esters or acid chlorides and preferably aliphatic linear polyols. Mixtures of dicarboxylic acids and/or derivatives thereof are also suitable. Examples of suitable dicarboxylic acids are adipic acid, succinic acid, sebacic acid or dodecanedioic acid. Preference is given to succinic acid, adipic acid and sebacic acid and mixtures thereof, particular preference to succinic acid and adipic acid and mixtures thereof, and very particular preference to adipic acid. These are used in amounts of at least 90 mol %, preferably of 95 to 100 mol %, based on the total amount of all carboxylic acids.

The difunctional polyester polyols A(i) may be prepared for example by polycondensation of dicarboxylic acids with polyols. The polyols preferably have a molecular weight of 62 to 399 g/mol, consist of 2 to 12 carbon atoms, are preferably unbranched, difunctional, and preferably have primary OH groups.

Examples of polyols that may be used for the preparation of the polyester polyols A(i) include polyhydric alcohols, for example ethanediol, di-, tri-, or tetraethylene glycol, propane-1,2-diol, di-, tri-, or tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol or mixtures thereof.

Preferred polyol components for the polyester polyols A(i) are ethane-1,2-diol, butane-1,4-diol, and hexane-1,6-diol; particular preference is given to butane-1,4-diol and hexane-1,6-diol, very particular preference is given to butane-1,4-diol.

The polyester polyols A(i) may be formed from one or more polyols. In a preferred embodiment of the present invention, they are formed from just one polyol.

When the crystalline or semicrystalline difunctional polyester polyols having a number-average molecular weight of at least 400 g/mol and a melting temperature of at least 35° C. have a heat of fusion of at least 50 J/g, the polymer prepared using the same will regularly have a heat of fusion of ≥35 J/g. If desired, the heat of fusion of the polymer can be adjusted by slightly modifying the content of polyester polyol A(i) in the composition or by slightly varying the heat of fusion of the polyester polyol. These measures require only exploratory tests and are completely within the practical experience of a person of average skill in the art in this field.

The preparation of polyester polyols A(i) is known from the prior art.

The number-average molecular weight of the polyester polyols A(i) is preferably 400 to 4000 g/mol, more preferably 1000 to 3000 g/mol, particularly preferably 1500 to 2500 g/mol, very particularly preferably 1800 to 2400 g/mol.

The melting temperature of the crystalline or semicrystalline polyester polyols is generally at least 35° C., preferably 40 to 80° C., particularly preferably 42 to 60° C., and very particularly preferably 45 to 52° C. The heat of fusion is ≥35 J/g, preferably ≥40 J/g, and particularly preferably ≥50 J/g.

Examples of difunctional polyol components having a molecular weight of 62 to 399 g/mol that are suitable as synthesis component A(ii) include the polyols mentioned for the preparation of the polyester polyols A(i). Low-molecular-weight polyester diols, polyether diols, polycarbonate diols or other polymer diols are in principle also suitable, provided they have a molecular weight of 62 to 399 g/mol.

Suitable synthesis components A(iii) are any organic compounds having at least two free isocyanate groups per molecule. Preference is given to using diisocyanates Y(NCO)₂, where Y is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms. Examples of such diisocyanates that are to be used with preference include tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanato-2,2-dicyclohexylpropane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures consisting of these compounds.

It is also possible to additionally use proportions of higher-functionality polyisocyanates known per se in polyurethane chemistry, or else modified polyisocyanates known per se and for example comprising carbodiimide groups, allophanate groups, isocyanurate groups, urethane groups and/or biuret groups.

In addition to these simple diisocyanates, polyisocyanates containing heteroatoms in the radical linking the isocyanate groups and/or having a functionality of more than 2 isocyanate groups per molecule are also suitable. The former are, for example, polyisocyanates that have been produced through modification of simple aliphatic, cycloaliphatic, araliphatic and/or aromatic diisocyanates, are formed from at least two diisocyanates, and have a uretdione, isocyanurate, urethane, allophanate, biuret, carbodiimide, iminooxadiazinedione and/or oxadiazinetrione structure. An example of an unmodified polyisocyanate having more than 2 isocyanate groups per molecule is 4-isocyanatomethyloctane 1,8-diisocyanate (nonane triisocyanate).

Particularly preferred synthesis components A(iii) are hexamethylene diisocyanate (HDI) and 1-isocyanato-3,3,5-trimethyl-5-isocyanatomethylcyclohexane (IPDI), and mixtures thereof.

Preferred isocyanate-reactive components A(iv) bearing at least one ionic or potentially ionic group are mono- and dihydroxycarboxylic acids, mono- and diaminocarboxylic acids, mono- and dihydroxysulfonic acids, mono- and diaminosulfonic acids, and also mono- and dihydroxyphosphonic acids or mono- and diaminophosphonic acids and alkali metal and ammonium salts thereof. Examples are dimethylolpropionic acid, dimethylolbutyric acid, hydroxypivalic acid, N-(2-aminoethyl)-β-alanine, N-(2-aminoethyl)-2-aminoethanesulfonic acid, N-(2-aminoethyl)-2-aminoethanecarboxylic acid, ethylenediaminepropyl- or -butylsulfonic acid, propylene-1,2- or -1,3-diamine-β-ethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, example 1) and the alkali metal and/or ammonium salts thereof; the adduct of sodium bisulfite to but-2-ene-1,4-diol, polyethersulfonate, the propoxylated adduct of 2-butenediol and NaHSO₃, described for example in DE-A 2 446 440 (pages 5-9, formulas I-III). Of good suitability for salt formation are hydroxides of sodium, potassium, lithium, and calcium and also tertiary amines such as triethylamine, dimethylcyclohexylamine, and ethyldiisopropylamine. Other amines may also be used for salt formation, for example ammonia, diethanolamine, triethanolamine, dimethylethanolamine, methyldiethanolamine, aminomethylpropanol, and also mixtures of the specified and also other amines. It is advantageous when these amines are added only once the isocyanate groups have largely reacted.

Also suitable as component A(iv) are structural units that can be converted into cationic groups by addition of acids, such as N-methyldiethanolamine.

Particularly preferred components A(iv) are ones having carboxyl and/or carboxylate and/or sulfonate groups.

Very particular preference is given to the sodium salts of N-(2-aminoethyl)-2-aminoethanesulfonic acid and of N-(2-aminoethyl)-2-aminoethanecarboxylic acid, especially of N-(2-aminoethyl)-2-aminoethanesulfonic acid.

Isocyanate-reactive components A(v) may for example be polyoxyalkylene ethers containing at least one hydroxyl or amino group. The commonly used polyalkylene oxide polyether alcohols are obtainable in a manner known per se by alkoxylation of suitable starter molecules. Alkylene oxides suitable for the alkoxylation reaction are especially ethylene oxide and propylene oxide, which may be used in the alkoxylation reaction. individually or else together.

Further examples of isocyanate-reactive components A(v) are monoamines, diamines and/or polyamines, and mixtures thereof. Examples of monoamines are aliphatic and/or alicyclic primary and/or secondary monoamines such as ethylamine, diethylamine, the isomeric propyl- and butylamines, higher linear aliphatic monoamines, and cycloaliphatic monoamines such as cyclohexylamine. Further examples are amino alcohols, i.e. compounds containing amino and hydroxyl groups in the same molecule, for example ethanolamine, N-methylethanolamine, diethanolamine or 2-propanolamine. Examples of diamines are ethane-1,2-diamine, hexamethylene-1,6-diamine, 1-amino-3,3,5-trimethyl-5-aminomethylcyclohexane (isophoronediamine), piperazine, 1,4-diaminocyclohexane and bis(4-aminocyclohexyl)methane. Also suitable are adipic dihydrazide, hydrazine and hydrazine hydrate. Further examples are amino alcohols, i.e. compounds containing amino and hydroxyl groups in the same molecule, for example 1,3-diamino-2-propanol, N-(2-hydroxyethyl)ethylenediamine or N,N-bis(2-hydroxyethyl)ethylenediamine. Examples of polyamines are diethylenetriamine and triethylenetetramine.

In a preferred form of the invention, the at least one polyurethane used according to the invention contains, for adjusting the molar mass, at least one monoamine and/or at least one diamine as isocyanate-reactive component A(v).

The at least one polyurethane present in the aqueous formulation according to the invention can generally be prepared by any method known to those skilled in the art. They are preferably prepared by the acetone process. The use and performance of the acetone process is prior art and is known to those skilled in the art.

In a specific embodiment of the invention, the at least one polyurethane contains a polyester obtained from adipic acid and butane-1,4-diol as component A(i), a mixture of hexamethylene diisocyanate (HDI) and 1-isocyanato-3,3,5-trimethyl-5-isocyanatomethylcyclohexane (IPDI) as component A(iii), the sodium salt of N-(2-aminoethyl)-2-aminoethanesulfonic acid as component A(iv), and diethanolamine as component A(v).

In another specific embodiment of the invention, the at least one polyurethane contains a polyester obtained from adipic acid and butane-1,4-diol as component A(i), butane-1,4-diol as component A(ii), a mixture of hexamethylene diisocyanate (HDI) and 1-isocyanato-3,3,5-trimethyl-5-isocyanatomethylcyclohexane (IPDI) as component A(iii), the sodium salt of N-(2-aminoethyl)-2-aminoethanesulfonic acid as component A(iv), and diethanolamine as component A(v).

In a further specific embodiment, polymer A and/or D contains the same or different reactive groups, which can react with one another for example as a result of evaporation of water from the formulation or of the coalescence of polymer particles, resulting after application of the adhesive in crosslinking of polymers A and/or D. These are for example alkoxysilane and/or silanol groups. The methods for incorporating such groups into polymers A and/or D are known to those of average skill in the art. For example, in the preparation of component A and/or D, when component D is a polyurethane, compounds that contain alkoxysilane or silanol groups can in principle be used in each of the described components ai-av. The alkoxysilane or silanol groups are preferably incorporated into polymer A and/or—if present—D by using as component av an appropriate proportion of compounds having alkoxysilane or silanol groups, for example aminosilanes such as aminopropylethoxysilane or aminopropylmethoxysilane.

The at least one polyurethane (component A) is present in the mixture present in the aqueous adhesive formulation according to the invention in an amount of from 30% to 94.9% by weight, preferably 52% to 80% by weight, more preferably 55% to 75% by weight, in each case based on the sum total of the amounts of the components A, B, C, and optionally D present in the mixture.

According to the invention, the nonvolatile fraction is understood as meaning the residual mass after evaporation determined by the method according to DIN EN ISO 3251:2019 (1 g/1 h, 125° C.).

Component B:

The mixture according to the invention comprises as component B at least one plasticizer.

The plasticizers used are according to the invention preferably low-volatility, low-molecular-weight compounds containing polar groups.

Examples of preferred plasticizers are di(phenoxyethyl) formal, low-volatility esters based on aromatic carboxylic acids, for example phthalic acid, isophthalic acid, terephthalic acid, benzoic acid or trimellitic acid, aliphatic carboxylic acids, for example maleic acid, fumaric acid, succinic acid, acetic acid, propionic acid, butyric acid, adipic acid, azelaic acid, sebacic acid or citric acid, cyclohexanedicarboxylic acids, fatty acids, for example oleic acid, ricinoleic acid or stearic acid, phosphoric esters, sulfonic esters or alkylsulfonic esters, epoxidized vegetable oils, for example epoxidized linseed oil or epoxidized soybean oil.

Particular preference according to the invention is given to using as component B di(phenoxyethyl) formal, dibutyl terephthalate, alkylsulfonic esters of phenol, and esters of monools and polyols based on benzoic acid. Very particularly preferably, the at least one plasticizer is selected from the group consisting of di(phenoxyethyl) formal, dibutyl terephthalate, dipropylene glycol dibenzoate, and mixtures thereof.

Further preference according to the invention is given to using as the plasticizer di(phenoxyethyl) formal or dipropylene glycol dibenzoate, especially dipropylene glycol dibenzoate.

Preference according to the invention is given to using as component B plasticizers that result in swelling of the at least one polyurethane (component A), which is manifested for example by the increase in the viscosity of the adhesive formulation according to the invention compared to a corresponding formulation in which the plasticizer is absent.

The at least one plasticizer (component B) is present in the mixture present in the adhesive formulation according to the invention in an amount of from 5% to 45% by weight, preferably 10% to 40% by weight, more preferably 10% to 35% by weight, in each case based on the sum total of the amounts of the components A, B, C, and optionally D present in the mixture.

Component C:

The mixture according to the invention also comprises as component C at least one salt. In general, all salts known to those skilled in the art may be used as component C.

Preference is given to using as component C salts selected from the group consisting of ammonium salts, alkali metal salts, alkaline earth metal salts, aluminum salts, zinc salts, and mixtures thereof. More preferably, the salts used according to the invention have good solubility in water, i.e. a solubility in water of at least 0.5 mol/I at 20° C. Preference according to the invention is given to using salts of monovalent cations. Particular preference is given to using as component C at least one salt selected from the group consisting of ammonium salts, sodium salts, potassium salts, lithium salts, and mixtures thereof. Further preference is given to using as component C at least one salt based on at least one anion derived from at least one acid that dissociates strongly in aqueous solution, further preferably of at least one acid having a pKa of less than 3. Component C is accordingly preferably present in the adhesive formulation according to the invention in dissociated form as cations and anions dissolved in water.

Further preference according to the invention is given to using as component C at least one salt selected from the group consisting of lithium salts, ammonium salts, sodium salts and/or potassium salts, the anion of which is chloride, bromide, iodide and/or sulfate. Very particular preference is given to chlorides.

The at least one salt used as component C according to the invention is therefore very particularly preferably selected from the group consisting of sodium chloride, potassium chloride, sodium sulfate, sodium carbonate, potassium sulfate, potassium carbonate, sodium hydrogen carbonate, potassium hydrogen carbonate, and mixtures thereof, with sodium chloride most preferred.

It is also possible to use as component C mixtures of different salts according to the above description.

The at least one salt (component C) is present in the mixture present in the aqueous adhesive formulation according to the invention in an amount of from 0.001% to 3% by weight, preferably 0.01% to 2% by weight, more preferably 0.05% to 1% by weight, in each case based on the sum total of the amounts of the components A, B, C, and optionally D present in the mixture.

The amount of at least one salt is preferably chosen such that the amount of at least one salt added to the adhesive formulation of the invention is the maximum that does not result in a significant occurrence of coagulum within the first 24 h after preparation of the adhesive formulation. This preferred amount of at least one salt can easily be adjusted by those skilled in the art on the basis of simple experiments in which the amount is increased until coagulum is clearly visible within a period of 24 h after preparation of the formulation.

The at least one salt is preferably dissolved in water before mixing with the other components of the adhesive formulation of the invention. The concentration of this solution is preferably chosen such that the water content in the adhesive formulation can be kept as low as possible while avoiding the occurrence, during incorporation, of transient local concentration spikes that can lead to coagulation during the addition of the salt solution. The salt solution used here preferably has a concentration of from 0.001 to 10 mol/l, particularly preferably 0.05 to 5 mol/l, very particularly preferably 0.1 to 2 mol/l.

Component D:

The mixture according to the invention optionally contains at least one further polymer as optional component D.

The at least one further polymer optionally present as component D is according to the invention different from the at least one polyurethane present as component A, although it is possible that at least one polyurethane is also present as component D but differs from the at least one polyurethane present as component A for example because the melting temperature and enthalpy of fusion are outside the ranges described for polymer A.

The at least one further polymer optionally present as component D is selected for example from the group consisting of PU (polyurethane), PVDC (polyvinylidene chloride), PVC (polyvinyl chloride), PVA (polyvinyl acetate), EVA (polyethylene vinyl acetate), PAC (polyacrylate), CR (polychloroprene), PS (polystyrene), SBR (polystyrene-butadiene), NBR (polyacrylonitrile), and mixtures thereof.

Further preference is given to using as component D at least one non-organohalogen-containing polymer. Particular preference is given to using, individually or in the form of a mixture, polyurethane or polyurethane-urea polymers, PAC, EVA and/or SBR that differ from component A according to the invention.

The at least one polymer optionally used as component D is preferably used in the form of an aqueous polymer dispersion.

If at least one further polymer is in accordance with the invention present as component D, it is generally present in the mixture present in the aqueous adhesive formulation according to the invention in an amount of from 1% to 40% by weight, preferably 3% to 30% by weight, more preferably 5% to 25% by weight, in each case based on the sum total of the amounts of the components A, B, C, and optionally D present in the mixture.

In general, the aqueous adhesive formulation according to the invention contains less than 55% by weight of water. Preferably, the aqueous adhesive formulation according to the invention contains 15% to 50% by weight, more preferably 25% to 50% by weight, particularly preferably 30% to 47% by weight, of water.

Thus, provided it does not contain any significant amounts of other volatile substances besides water, the nonvolatile fraction of the aqueous adhesive formulation according to the invention is generally higher than 45% by weight, preferably 50% to 85% by weight, more preferably 50% to 75% by weight, particularly preferably 53% to 70% by weight.

The present invention further relates to the aqueous adhesive formulation according to the invention, this comprising
(A) preferably 30% to 94.9% by weight, particularly preferably 52% to 80% by weight, very particularly preferably 55% to 75% by weight, of component A,
(B) preferably 5% to 45% by weight, particularly preferably 10% to 40% by weight, very particularly preferably 10% to 35% by weight, of component B,
(C) preferably 0.001% to 3% by weight, particularly preferably 0.01% to 2% by weight, very particularly preferably 0.05% to 1% by weight, of component C, and
(D) if component D is present, preferably 1% to 30% by weight, particularly preferably 3% to 30% by weight, very particularly preferably 5% to 25% by weight, of component D,

in each case based on the sum total of the amounts of components A, B, C, and optionally D present in the mixture. The sum total of the amounts of components A, B, C, and optionally D present in the mixture of the invention is according to the invention 100% by weight.

In addition to the mentioned mixture containing components A, B, C and optionally D, further additives may optionally be present in the adhesive formulation according to the invention, for example in an amount of from 0% to 15% by weight, preferably 0.1% to 15% by weight, in each case based on the nonvolatile fraction of the adhesive formulation according to the invention.

Suitable additives are for example selected from the group consisting of emulsifiers, thickeners, wetting agents, flame retardants, preservatives, light stabilizers, antioxidants, defoamers, solvents, anti-ageing agents, antioxidants, UV stabilizers, tackifier resins, fresh sols, silica sols, and mixtures thereof.

Suitable emulsifiers, in particular for stabilizing the adhesive formulation of the invention, are for example external emulsifiers, in particular nonionic emulsifiers such as ethoxylated and/or propoxylated fatty alcohols, for example stearyl alcohol polyglycol ethers. These are used, in each case based on the nonvolatile fraction of the aqueous adhesive formulation of the invention, in an amount of, for example, 0.05% to 5% by weight, preferably 0.2% to 2.5% by weight, very particularly preferably 0.5% to 1.5% by weight. If at least one emulsifier is used in the adhesive formulation of the invention, the amount of the at least one salt (component C) may have to be adjusted, more particularly increased. This can be determined by those skilled in the art on the basis of exploratory tests.

The aqueous adhesive formulation of the invention preferably contains no external emulsifiers.

According to the invention, it is for example possible to employ associative and/or non-associative thickeners, such as are known to those skilled in the art for the formulation of coatings and adhesives based on polyurethane dispersions.

In further, but not preferred, embodiments, what are known as in-can preservatives may be added for preservation. These may be used for example in an amount of from 0.002% to 0.5% by weight based on the nonvolatile fraction of the aqueous adhesive formulation. Suitable compounds are for example compounds from the group of the isothiazolones, especially benzisothiazolinone (BIT), methylisothiazolinone (MIT) or chloromethylisothiazolinone (CMIT).

“Tackifier resins” refer to resins that act as a tackifier and that increase the adhesion capacity of an adhesive. Tackifier resins that may be used include both natural and synthetic resins, for example aliphatic, aromatically modified, aromatic or hydrogenated hydrocarbon resins, terpene resins, modified terpene resins and terpene phenol resins, or tree resin derivatives, for example colophony resins, modified colophony resins, for example colophony-based resin esters (rosin esters), balsam resin derivatives (gum rosin), and tall oil derivatives (tall oil rosin). The tackifier resins may be used individually or in the form of mixtures. The tackifier resins used are preferably colophony resins and modified colophony resins. Particular preference is given to using colophony-based resin esters. The tackifier resins may be used in the adhesive formulation of the invention as the bulk substance or in water-dispersed form, provided they are compatible, for example stable to phase separation. In a particularly preferred embodiment of the present invention, aqueous dispersions of colophony resin esters (rosin ester dispersions) are used. If tackifier resins are used, they are used in an amount preferably of from 0.5% to 15% by weight based on the nonvolatile fraction of the aqueous adhesive formulation of the invention.

Also possible, although not preferred, is the use of organic solvents in the aqueous adhesive formulation of the invention, for example toluene, xylene, butyl acetate, methyl ethyl ketone, ethyl acetate, dioxane or mixtures thereof, in each case in an amount of preferably 0.5% to 10% by weight based on the nonvolatile fraction of the aqueous adhesive formulation of the invention.

Customary anti-ageing agents, antioxidants and/or UV stabilizers are for example those based on oligofunctional secondary aromatic amines or oligofunctional substituted phenols. Corresponding anti-ageing agents, antioxidants and/or UV stabilizers are typically introduced in emulsified form as an aqueous dispersion. Anti-ageing agents, antioxidants and/or UV stabilizers may according to the invention be used in an amount of from 0.1% to 5% by weight, preferably 1% to 3% by weight, more preferably 1.5% to 2.5% by weight, in each case based on the nonvolatile fraction of the aqueous adhesive formulation of the invention.

Fresh and/or silica sols may be used as further additives, for example to reduce the costs of the adhesive formulation. Silica sols have long been known. Silica sols are colloidal solutions of amorphous silicon dioxide in water. The silicon dioxide is preferably in the form here of spherical particles having surface hydroxylation. The particle diameter of the colloid particles is generally 1 to 200 nm (determined by laser diffraction); the specific BET surface area, which is determined by the method of G. N. Sears, Analytical Chemistry vol. 28, No. 12, pages 1981 to 1983, December 1956 and correlates with particle size, is 15 to 2000 m²/g. The surface of the SiO₂ particles preferably has a charge that is compensated by a corresponding counterion that results in stabilization of the colloidal solution. The alkali-stabilized silica sols have for example a pH of 7 to 11.5 and contain as alkalizing agents for example small amounts of Na₂O, K₂O, Li₂O, ammonia, organic nitrogen bases, tetraalkylammonium hydroxides or alkali metal or ammonium aluminates. Silica sols may also be present in weakly acidic form as semistable colloidal solutions. According to the invention, at least one modified silica sol is used. For example, it is possible to obtain modified, especially surface-modified, silica sols by coating the surface with metal-containing compounds, especially aluminum-containing compounds, for example Al₂(OH)₅Cl. Suitable silica sols are available for example under the trade name Dispercoll® S from Covestro, Leverkusen.

In the context of the present invention, the term “fresh sol” is understood as meaning a dilute solution of silica Si(OH)₄.

If silica sols and/or fresh sol are used, they are used in an amount of preferably 0.5% to 5% by weight based on the nonvolatile fraction of the aqueous adhesive formulation of the invention.

The adhesive formulations according to the invention are produced by mixing the components with one another.

The present invention therefore also relates to a method for producing the aqueous adhesive formulation of the invention by mixing the individual components.

The aqueous adhesive formulation according to the invention is produced preferably by mixing an aqueous polyurethane dispersion (component A) with the at least one plasticizer (component B) and optionally a dispersion of the at least one further polymer (component D) and an aqueous solution of the at least one salt (component C).

In a particularly preferred embodiment of the method according to the invention, components A and B and optionally component D are first mixed. Component C is preferably added to this mixture after the mixture of components A, B, and optionally D has reached a constant viscosity.

The method according to the invention for producing the aqueous adhesive formulation of the invention, and also the production of the individual solutions or dispersions used, can generally be carried out under all conditions that appear suitable to those skilled in the art, for example at a temperature of 18 to 28° C., ideally at room temperature (23° C.), further preferably in apparatus known to those skilled in the art, for example in stainless steel, glass or enameled process apparatus. During production of the aqueous adhesive formulation of the invention, the formation of rust and soluble metal alloys, including from aluminum containers, must be avoided.

The present invention also relates to the method according to the invention for producing an adhesive bond between substrates, wherein an adhesive formulation according to the invention is applied to at least one substrate, after which bonding takes place, for example after max. 5 min, preferably after max. 2 min, more preferably after max. 1 min. The bonding according to the invention preferably takes place before film formation is complete. This method according to the invention is also called the 1K, or 1-component, method.

The adhesive formulation according to the invention can generally be applied to the substrates by means of all commonly used forms of application, especially by painting, rolling, atomizing and/or spraying, in particular by spray application, brush application or roller application. The adhesive formulation according to the invention is preferably applied by spray application. In general, it is advantageous when application gives rise to a certain shear stress on the formulation, for example during passage through the spray nozzle.

Examples of substrates that are suitable according to the invention are wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case with one another and/or on porous substrates, preferably having a density of less than 1 kg/liter.

More particularly, the present invention relates to the method according to the invention for producing an adhesive bond wherein an adhesive composition according to the invention is applied to a foam substrate, for example by spray application, roller application or brush application and, after a flash-off time of preferably less than 5 min, particularly preferably less than 2 min, very particularly preferably less than 1 min, wet bonding is achieved prior to film formation.

The present invention in addition also relates to the method according to the invention for producing a composite material by bonding the individual joining parts of the composite material using the aqueous adhesive formulation of the invention.

The present invention also relates to the use of the adhesive formulation of the invention for the bonding of wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case with one another and/or on porous substrates, preferably having a density of less than 1 kg/liter, especially for the bonding of foams in the adhesive bonding of mattresses, furniture and/or upholstery, especially in a 1K (1-component) method or in a 2K (2-component) method, preferably in a 1K (1-component) method.

The adhesive formulation according to the invention can in addition also be used in a 2K (2-component) method (2K method).

The present invention in addition relates to the method according to the invention wherein it is carried out as a 2K (2-component) method.

Spraying here is usually carried out using atomizing air at a pressure of 0.1 to 5 bar; however, it is also possible to supply at least one of the two components airlessly, as described for example in WO 2015/137808. The coagulation of the dispersion takes place in the spray jet en route to the surface of the first substrate, this process being accompanied by the evaporation already of some of the water present in the adhesive dispersion. On contact with the surface of the first substrate, the adhesive polymer forms thereon a film that is immediately tacky in the still-wet state. Since the mixing of adhesive dispersion and coagulant does not take place until in the spray jet, no pot life needs to be taken into account. The tackiness of the polymer film in the wet state means that the second surface can be immediately joined, ideally for example by applying pressure on the substrates in the direction of the adhesive surface. Applying pressure by pressing the two substrate surfaces together is advantageous, since it increases the strength of the adhesive bond. It is likewise advantageous when at least one of the two substrates is porous or permeable to water, so as to make it possible for water to be transported away from the hardening adhesive joint.

Suitable coagulants include aqueous solutions of salts, preferably of metals of the first, second, and third main group of the periodic table, especially ones having good solubility in water. Preference is given to using salts based on divalent or trivalent cations. Particular preference is given to using calcium chloride, zinc sulfate or aluminum sulfate. Very particular preference is given to using calcium chloride. Mixtures of different salts as per the above description can also be used as the aqueous solution.

The concentration of the salts in the aqueous salt solutions suitable as coagulant is for example 1% to 20% by weight, preferably 2% to 10% by weight, and more preferably 3% to 4% by weight. The proportion of the aqueous solution of the coagulant, based on the total adhesive solution plus coagulant solution, is for example 0.1% to 50% by weight, preferably 1% to 30% by weight, particularly preferably 8% to 20% by weight, and very particularly preferably 12% to 18% by weight.

Alternatively, it is also possible to use as coagulant aqueous solutions of inorganic or organic acids, preferably citric acid, phosphoric acid or carbonic acid, and mixtures of one or more of the abovementioned salts with one or more of these acids. The present invention is more particularly elucidated by means of the examples that follow.

### EXAMPLES

Starting Materials
Polyester I: Polyester diol formed from butane-1,4-diol and adipic acid, OH value 50
Polyester II: Polyester diol formed from hexane-1,6-diol, neopentyl glycol, and adipic acid, OH value 56
Polyester III: Polyester diol formed from hexane-1,6-diol and phthalic anhydride, OH value 56
Desmodur® H: Hexamethylene 1,6-diisocyanate (Covestro Deutschland AG, Leverkusen/Germany)
Desmodur® I: Isophorone diisocyanate (Covestro Deutschland AG, Leverkusen/Germany)
Lucramul® 1820 liq: Emulsifier, 15% by weight solution of stearyl alcohol polyglycol ether in water (Levaco Chemicals GmbH, Leverkusen)
Benzoflex® 9-88: Dibenzoate-based plasticizer, principal constituent dipropylene glycol dibenzoate (CAS No. 27138-314, Eastman)

### Example 1

Preparation of an Aqueous Polyurethane Dispersion

450 g of polyester I and 42.67 g of polyester II are dewatered at 110° C. and 15 mbar A for 1 hour. At 60° C., first 2.24 g of butane-1,4-diol and then a mixture of 38.02 g of Desmodur® H and 25.11 g of Desmodur® I are added while stirring. The mixture is heated to 80° C. and stirred until a constant isocyanate content of 1.30% by weight has been attained. The reaction mixture is dissolved in 770 g of acetone and cooled to 48° C. To the homogeneous solution is added a solution of 6.56 g of the sodium salt of N-(2-aminoethyl)-2-aminoethanesulfonic acid and 5.16 g of diethanolamine in 100 g of water with vigorous stirring. After 30 minutes, the mixture is dispersed by addition of 470 g of water. Distillative removal of the acetone affords an aqueous polyurethane-polyurea dispersion having a nonvolatile fraction of 50.0% by weight. The polymer present is after drying semicrystalline, with a melting temperature of 49° C. and an enthalpy of fusion of 57.0 J/g.

### Example 2

Preparation of an Aqueous Polyurethane Dispersion

450 g of polyester I and 42.67 g of polyester II are dewatered at 110° C. and 15 mbar A for 1 hour. At 60° C., first 2.24 g of butane-1,4-diol and then a mixture of 38.02 g of Desmodur® H and 25.11 g of Desmodur® I are added while stirring. The mixture is heated to 80° C. and stirred until a constant isocyanate content of 1.30% by weight has been attained. The reaction mixture is dissolved in 770 g of acetone and cooled to 48° C. To the homogeneous solution is added a solution of 6.56 g of the sodium salt of N-(2-aminoethyl)-2-aminoethanesulfonic acid and 5.16 g of diethanolamine in 100 g of water with vigorous stirring. After 30 minutes, the mixture is dispersed by addition of 445 g of water. After distillative removal of the acetone, 30.8 g of Lucramul® 1820 liquid is added while stirring. An aqueous polyurethane-polyurea dispersion having a nonvolatile fraction of 50.0% by weight is obtained. The polymer present is after drying semicrystalline, with a melting temperature of 49° C. and an enthalpy of fusion of 56.0 J/g.

### Example 3

Preparation of an Aqueous Polyurethane Dispersion.

450 g of polyester I is dewatered at 110° C. and 15 mbar A for 1 hour. At 80° C., 30.11 g of Desmodur® H and then 20.14 g of Desmodur® I are added. The mixture is stirred at 80 to 90° C. until a constant isocyanate content of 1.15% by weight has been attained. The reaction mixture is dissolved in 750 g of acetone and cooled to 48° C. To the homogeneous solution is added a solution of 5.95 g of the sodium salt of N-(2-aminoethyl)-2-aminoethanesulfonic acid and 2.57 g of diethanolamine in 65 g of water with vigorous stirring. After 30 minutes, the mixture is dispersed by addition of 700 g of water. Distillative removal of the acetone affords an aqueous polyurethane-polyurea dispersion having a nonvolatile fraction of 40.0% by weight. The polymer present is after drying semicrystalline, with a melting temperature of 48° C. and an enthalpy of fusion of 50.4 J/g.

### Example 4: (Comparative Example)

Preparation of an Aqueous Polyurethane or Polyurethane-Urea Dispersion.

1215 g of polyester III is dewatered at 110° C. and 15 mbar A for 1 hour. At 80° C., 4.6 g of hexane-1,6-diol and 179.0 g of Desmodur® H are added and the mixture is stirred at 90° C. until a constant isocyanate content of 2.28% by weight has been attained. The reaction mixture is dissolved in 2490 g of acetone and cooled to 48° C. To the homogeneous solution is added a solution of 31.9 g of the sodium salt of N-(2-aminoethyl)-2-aminoethanesulfonic acid in 300 g of water with vigorous stirring. After 30 minutes, the mixture is dispersed by addition of 1150 g of water. Distillative removal of the acetone affords an aqueous polyurethane-polyurea dispersion having a nonvolatile fraction of 50.0% by weight. The polymer present is after drying amorphous, i.e. it has no melting peak in the DSC.

Preparation of the Adhesive Formulations

The adhesive formulations were each prepared in a 900 ml poly beaker using a Visco Jet® stirrer. First of all, the dispersion of the polyurethane or polyurea (component A) is initially charged at a stirring speed of approx. 600 rpm, and the plasticizer (component B) then added with stirring. After the addition of the plasticizer and in the course of the mixing process, the viscosity increases substantially. The stirring speed must here be adjusted until a vortex develops again at the stirring rod. At the end of the stirring time of 120 min, the salt solution (component C), which had previously been prepared by dissolving the salt in water in the specified concentration, is added.

After stirring for a further 15 min, the formulation is checked for development of a coagulum by filtration using a nylon fabric filter with a pore size of 125 μm (E-D-Schnellsieb® super fine 125my (blue nylon fabric)). If no clearly visible coagulum is found on the filter here, the formulation is transferred to a glass bottle and this is sealed. After being left to stand for at least 12 hours, the formulation is checked again for coagulum by filtration as described above. The formulations are considered sufficiently storage stable if no clearly visible coagulum is present on the filter even after the second filtration. In case of doubt, the amount of coagulum left on the filter must be determined. The mass of the coagulum on the filter paper is determined by drying and then reweighing the filter paper. The requirement for storage stability is considered to be met if the amount of coagulum does not exceed the amount corresponding to 1% by weight of the amount of polymer A and—if present—D (total amount) contained in the adhesive formulation.

Methods/Measurement Methods:

The following methods/measurement methods were employed in the examples according to the invention and/or comparative examples.

Application of the Adhesive Formulation and Assessment

1) Spray method 1): A standard spray gun for two-component dispersion adhesives (Waltherbond 2K from Walther Pilot) was used for application without coagulant over the whole surface. The application weight was determined by reweighing the substrates immediately after application.

The following spray gun settings were used:
Adhesive component: Feed pressure 1.3 to 1.5 bar
Atomizer air pressure: 2.8 bar
Bore (nozzle) for adhesive component 0.8 mm
Material nozzle rotation: 0.5 to 1 rotation
Weight applied: 100 to 200 g/m² (wet)

2) Spray Method 2)

A Wagner paint spray system with the Wood&Metal Extra Detail spray attachment was used, article number: 2361 744, compressed air: 1.0-1.5 bar.

3) Test Specimens

The PU foam bodies described below were used.

stn/schaumstoff-technik-Nlrnberg GmbH, type ST 5540, dimensions of the test specimens: 100 mm×50 mm×30 mm, material basis PUR, color white, net bulk density 38 kg/m³ according to ISO-845: 2009-10, compression hardness at 40% 5.5 (kPa) according to DIN EN ISO 3386: 2015-10, tensile strength >120 kPa according to DIN EN ISO 1798: 2008-04, elongation at break >110% according to ISO-1798: 2008-04, compression set <4% according to DIN EN ISO-1856: 2018-11 (50%/70° C./22 h)

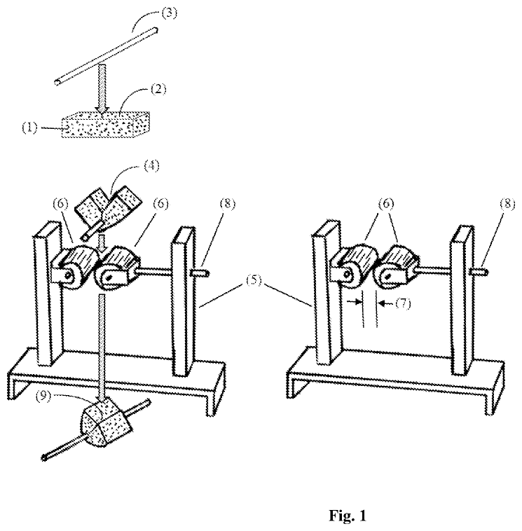

4) Determination of Initial Strength (See FIG. 1)

Test specimens as described under 3) are used as test material. To assess the initial strength, immediately after application of adhesive to the upper surface (2) of the foam bodies (1) by the spray method (amount applied 100 to 200 g/m² wet), the test specimens are folded (4) in the middle with a wooden rod (3) (7×7 mm square-end) and passed by means of the test apparatus (5) through 2 steel rollers (6) (diameter 40 mm, length 64 mm), the tangential spacing (7) of which had previously been adjusted to 10 mm using a threaded spindle (8).

5) Assessment of Initial Strength

Very Good (1):

The tension is immediately maintained after pulling the test specimen through the nip between the two rollers once. On pulling the two sides of the foam body apart after 120 seconds, the material tears or the foam body can be opened again only with great effort.

Good (2):

The tension is immediately maintained after pulling the test specimen through the nip between the two rollers once and, on pulling the two sides apart, the foam body can be opened again after 120 seconds without great effort.

Deficient (3):

The test specimen opens after pulling the test specimen through the nip between the two rollers once. Test specimen remains closed only by repeating this or by exerting manual pressure (applying pressure 1× for approx. 1 s).

Inadequate (4):

The tension is not maintained even after applying pressure (roller method and exertion of manual pressure) multiple times.

6) Determination of Glass Transition Temperatures, Melting Temperatures, and Enthalpies of Fusion by DSC:

The glass transition temperatures and the melting temperatures and enthalpies of fusion were determined by differential scanning calorimetry (DSC) using a Pyris Diamond DSC calorimeter from Perkin-Elmer.

For this purpose, a film was produced by knife coating the dispersion onto a glass plate at a wet-film thickness of 100 μm and drying this in a dry box for 3 days at room temperature and 0% room humidity. The DSC curve was then recorded using 10 mg of sample material with the following measurement conditions: Rapid cooling to the starting temperature of −100° C., then start of three heatings from −100 to +150° C. at a heating rate of 20 K/min and a cooling rate of 320 K/min under a helium atmosphere and cooling with liquid nitrogen. The glass transition temperature corresponds to the temperature at half height of the glass transition, it being the third heating that was evaluated. For the determination of the melting temperatures and enthalpies of fusion, the first heating was evaluated.

TABLE 1
Tests on formulations according to the
invention and comparative formulations

| | Example No. | | |
|---|---|---|---|
| Ingredient | 5 | C6 | C7 |
| Polymer dispersion from example 1 | 78.74 | 78.74 | — |
| Polymer dispersion from example 4 | — | — | 78.74 |
| Benzoflex ® 9-88 | 17.32 | 17.32 | 17.32 |
| NaCl solution in DM water c = 20 g NaCl/l | 3.94 | — | — |
| NaCl solution in DM water c = 58 g NaCl/l | — | — | 3.94 |
| Demineralized (DM) water | — | 3.94 | — |
| Total | 100 | 100 | 100 |
| Residue on filter after 24 h [g] | 0 | 0 | 0 |
| Initial strength * | 2 | 4 | 4 |

C Comparative
All data in % by weight unless otherwise stated.
* Spray method 1: Walther Pilot settings 1.2 bar material, 2.5 bar atomizer, material nozzle: 1.0 revolution, amount applied: 0.5 g (corresponds to 100 g/m²)

The results presented in Table 1 show that the combination of components A, B, and C according to the invention results in good initial strength and good storage stability (example 5), whereas the absence of component C according to the invention (example C6) and use only of an amorphous polyurethane (example C7) does not result in good initial strengths.

TABLE 2
Tests on formulations according to the invention and comparative formulations

| | Example No. | | | | | |
|---|---|---|---|---|---|---|
| Ingredient | 8 | 9 | C10 | C11 | C12 | C13 |
| Polymer dispersion from example 1 | 78.74 | — | 96.00 | — | 81.95 | 78.70 |
| Polymer dispersion from example 2 | — | 47.10 | — | — | — | — |
| Polymer dispersion from example 3 | — | 25.35 | — | | — | — |
| Polymer dispersion from example 4 | — | 6.33 | — | 78.74 | — | — |
| Benzoflex ® 9-88 | 17.32 | 17.32 | — | 17.32 | 18.05 | 17.30 |
| NaCl solution in DM water c = 20 g NaCl/l | 3.94 | — | — | — | — | — |
| NaCl solution in DM water c = 58 g NaCl/l | — | 3.90 | 4.00 | 3.94 | — | — |
| Demineralized (DM) water | — | — | — | — | — | 4.00 |
| Total | 100 | 100 | 100 | 100 | 100 | 100 |
| Residue on filter after 24 h [g] | 0 | 0 | 0 | 0 | 0 | 0 |
| Initial strength* | 2 | 2 | 4 | 4 | 4 | 4 |

C Comparative
All data in % by weight unless otherwise stated.
*Spray method 2: Wagner atomizer pressure: <1.0 bar, amount applied: 0.4-0.6 g (corresponds to 100 g/m²)

The tests with a simple spray gun presented in Table 2 show that only the combination of components A, B, and C according to the invention results in good initial strengths immediately after application and good storage stability (examples 8 and 9). In the absence of components A (example C11), B (example C10), and C (examples C12 and C13), satisfactory initial strengths are in each case not obtained. Likewise good initial strengths are then obtained when an amorphous polyurethane (polymer from example 4) is used as component D).

TABLE 3
Tests on formulations according to the invention with various salts

| | Example No. | | |
|---|---|---|---|
| Ingredient | 14 | 15 | 16 |
| Polymer dispersion from example 1 | 78.74 | 78.74 | 78.74 |
| Benzoflex ® 9-88 | 17.32 | 17.32 | 17.32 |
| KCl (0.15 mol/l in DM water) | 3.94 | — | — |
| LiCl (0.15 mol/l in DM water) | — | 3.94 | — |
| NH₄Cl (0.15 mol/l in DM water) | — | — | 3.94 |
| Total | 100 | 100 | 100 |
| Residue on filter after 24 h [g] | 0 | 0 | 0 |
| Initial strength* | 2 | 2 | 2 |

All data in % by weight unless otherwise stated.
*Application setting: Walther Pilot settings 1.2 bar material, 2.5 bar atomizer, material nozzle: 0.5 revolutions
Amount applied: 0.5-0.7 g (corresponds to 100 g/m²)

The results in Table 3 (examples 14-16) show that not just NaCl but also KCl, LiCl, and NH₄Cl as component C result in storage-stable formulations according to the invention that result in good initial strengths.

Use of the Adhesive Formulation of the Invention in the 2K Spray Coagulation Method:

Formulation 9 is applied using a standard spray gun for two-component dispersion adhesives, namely the Pilot III 2K from Walther Pilot. The adhesive and the coagulant CaCl₂ (3% by weight solution in water) are supplied to the spray gun separately, mixed in the spray jet and, the adhesive coagulated. Since mixing does not take place until in the spray jet, no pot life needs to be taken into account. A ratio of 86% by weight of adhesive dispersion and 14% by weight of CaCl₂ solution was chosen.

The exact settings of the spray gun are known in principle to those skilled in the art and can without undue effort be tailored to the specific case and determined by simple preliminary tests. The quantitative ratios and the applied weight can be determined by reweighing the reservoir vessels and the substrates.

The following settings were used:
a.) Adhesive component: feed pressure 1.3 bar
b.) Coagulation component: feed pressure 0.4 bar
c.) Atomizer air pressure: 2.8 bar
d.) Bore diameter (nozzle) for adhesive component: 1.0 mm
e.) Bore diameter (nozzle) for coagulant component: 0.4 mm
f.) Applied weight: 100 g/m² (wet)

The initial strength was likewise determined immediately after application of the adhesive formulation using the test specimens from stn/schaumstoff-technik-Niirnberg GmbH, model ST 5540, described above. The initial strength was found to be 2 (good).

1. An aqueous adhesive formulation comprising a mixture of:
(A) at least one semicrystalline or crystalline polyurethane having a melting temperature of 35 to 80° C. and an enthalpy of fusion of z 35 J/g as component A,
(B) at least one plasticizer as component B,
(C) at least one salt as component C, and
(D) optionally at least one further polymer as component D,
wherein
the mixture contains;
(A) 30% to 94.9% by weight of component A,
(B) 5% to 45% by weight of component B,
(C) 0.001% to 3% by weight of component C, and
(D) optionally 0% to 30% by weight of component D,
in each case based on the sum total of the amounts of components A, B, C, and optionally D present in the mixture.

2. The adhesive formulation as claimed in claim 1, wherein the at least one semicrystalline or crystalline polyurethane is formed from
A(i) at least one crystalline or semicrystalline difunctional polyester polyol having a number-average molecular weight of at least 400 g/mol and a melting temperature of at least 35° C. and a heat of fusion of at least 35 J/g,
A(ii) optionally at least one difunctional polyol component having a number-average molecular weight of 62 to 399 g/mol,
(Aiii) at least one isocyanate component,
(Aiv) at least one isocyanate-reactive component bearing at least one ionic or potentially ionic group, and
(Av) optionally further isocyanate-reactive components.

3. The adhesive formulation as claimed in claim 1, wherein the at least one plasticizer is selected from the group consisting of di(phenoxyethyl) formal, low-volatility esters based on aromatic carboxylic acids, aliphatic carboxylic acids, cyclohexanedicarboxylic acids, fatty acids, phosphoric esters, sulfonic esters or alkylsulfonic esters, epoxidized vegetable oils, and mixtures thereof.

4. The adhesive formulation as claimed in claim 1, wherein the at least one salt is selected from the group consisting of lithium salts, ammonium salts, sodium salts and/or potassium salts, as anion of which is chloride, bromide, iodide and/or sulfate.

5. The adhesive formulation as claimed in claim 1, wherein a nonvolatile fraction is higher than 45% by weight.

6. The adhesive formulation as claimed in claim 1, wherein at least one further polymer is present selected from the group consisting of PU (polyurethane), PVDC (polyvinylidene chloride), PVC (polyvinyl chloride), PVA (polyvinyl acetate), EVA (polyethylene vinyl acetate), PAC (polyacrylate), CR (polychloroprene), PS (polystyrene), SBR (polystyrene-butadiene), NBR (polyacrylonitrile), and mixtures thereof.

7. A method for producing the aqueous adhesive formulation as claimed in claim 1 by mixing the individual components.

8. A method for producing an adhesive bond between substrates, wherein an adhesive formulation as claimed in claim 1 is applied to at least one substrate, after which bonding takes place.

9. The method as claimed in claim 8, executed as a 1K (1-component) method or as a 2K (2-component) method.

10. A method for producing a composite material by bonding individual joining parts of the composite material by applying the aqueous adhesive formulation as claimed in claim 1.

11. A method for bonding of wood, paper, thermoplastics, elastomeric plastics, thermoplastic-elastomeric plastics, vulcanizates, textile fabrics, knitted fabrics, braids, leather, metals, ceramics, asbestos cement, stoneware, concrete, foams, in each case with one another and/or on porous substrates by applying the aqueous adhesive formulation as claimed in claim 1.

12. The method as claimed in claim 11, executed in a 1K (1-component) method or in a 2K (2-component) method.

13. The method as claimed in claim 9, executed as a 1K (1-component) method.

14. The method as in claim 11, for bonding foams in manufacture of mattresses, furniture and/or upholstery.
